(19) United States
(12) Patent Application Publication
(10) Pub. No.: US 2007/0113972 A1
(43) Pub. Date: May 24, 2007

(54) Method of manufacturing flexible laminate substrate

(75) Inventors: Takashi Kikuchi, Shiga (JP); Hiroyuki Tsuji, Kanagawa (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KANEKA CORPORATION, Osaka (JP)

(21) Appl. No.: 10/584,352

(22) PCT Filed: Dec. 20, 2004
(86) PCT No.: PCT/JP04/19491

§ 371 Date: Jun. 23, 2006

(30) Foreign Application Priority Data
Dec. 26, 2003 (JP) 2003-434215

(51) Int. Cl. B32B 37/12; B32B 37/26; B29C 65/02

(52) U.S. Cl. 156/289; 156/229; 156/324

(57) ABSTRACT

Disclosed is a method of manufacturing a flexible laminate substrate having an improved appearance and dimensional stability after removal of a metal foil. Specifically disclosed is a method of manufacturing a flexible laminate substrate 5 wherein a metal foil 2 is bonded to at least one surface of a heat-resistant adhesive film 3. The method comprises a step wherein the heat-resistant adhesive film 3 and the metal foil 2 are thermally laminated between a pair of metal rolls 4 via a protective film 1, thereby forming a laminate 7 wherein the heat-resistant adhesive film 3, the metal foil 2, and the protective film 1 are bonded together, and another step wherein the protective film 1 is removed. The tension of the laminate 7 at the time when the protective film 1 is removed is higher than the tension of the laminate 7 before the removal of the protective film 1.

### TECHNICAL FIELD

The present invention relates to a method manufacturing flexible laminate substrates, especially, a method of manufacturing flexible laminate substrates with an improved appearance and dimensional stability after removal of a metal foil.

### DISCLOSURE OF INVENTION

Flexible laminate substrates have been conventionally used as printed circuit boards in mobile phones and other electrical appliances. The flexible laminate substrate is a heat-resistant film of, for example, polyimide with copper or other metal foil bonded to at least one surface thereof.

A conventional flexible laminate substrate has been manufactured by bonding metal foil onto a heat-resistant film using an acrylic, epoxy, or other adhesive agent. A recent emerging trend is however flexible laminate substrates manufactured, not using any of these thermosetting adhesive agents, but by thermally laminating a heat-resistant adhesive film and a metal foil for improved heat-resistant and durability.

The flexible laminate substrate manufactured by thermal lamination boasts excellent heat-resistance because it includes a polyimide-based adhesive layer. In addition, the flexible laminate substrate has excellent durability as evidenced when it is used in the hinge of a folding unit of a clamshell-style mobile phone. The flexible laminate substrate using a thermosetting adhesive agent can be folded up to about thirty thousand times. In contrast, the flexible laminate substrate using a polyimide-based adhesive layer can be folded up to about a hundred thousand times.

During the manufacture of an electrical appliance, the flexible laminate substrate is subjected to intense heat, for example, in a solder reflow step. For improved thermal reliability of the flexible laminate substrate, the heat-resistant adhesive film typically contains a single or multiple adhesive layers with a glass transition temperature (Tg) not below 200° C. Therefore, the heat-resistant adhesive film and the metal foil need to be thermally laminated at a temperature above the Tg of the adhesive layer(s) in the heat-resistant adhesive film, or 200° C.: for example, at 300° C. or above.

In a thermal laminator, at least one of rolls used for thermal lamination is usually a rubber roll to alleviate pressure non-uniformity in thermal lamination. However, it is very difficult to thermally laminate at 300° C. or higher temperature using a rubber roll.

A method addressing this problem is to bond the heat-resistant adhesive film onto the metal foil using a double-belt press machine schematically illustrated in FIG. 4. A protective film 11, a metal foil 12, and a heat-resistant adhesive film 13 are thermally laminated by a metal belt 14 in a heating section 8 and then cooled in a cooling section 9. Thereafter, the protective film 1101 is delaminated, which completes the manufacture of the flexible laminate substrate 15. See Japanese Unexamined Patent Publication (Tokukai) 2001-129919.

The method fails, however, if the metal belt 14 is damaged even partly; the laminator cannot retain pressure uniformity in thermal lamination. To avoid this, time-consuming maintenance is needed frequently in which the entire surface of the metal belt 14 is polished for planarization of the surface, Furthermore, the maintenance leads to extra equipment cost.

In contrast, a thermal laminator with a pair of metal rolls requires less maintenance and hence less equipment cost. However, thermal lamination with a pair of metal rolls has problems. Unlike the rubber roll, it is difficult to retain pressure uniformity in thermal lamination. Also, quick rises in temperature in thermal lamination causes creases on the surface of the flexible laminate substrate, giving the flexible laminate substrate a poor appearance.

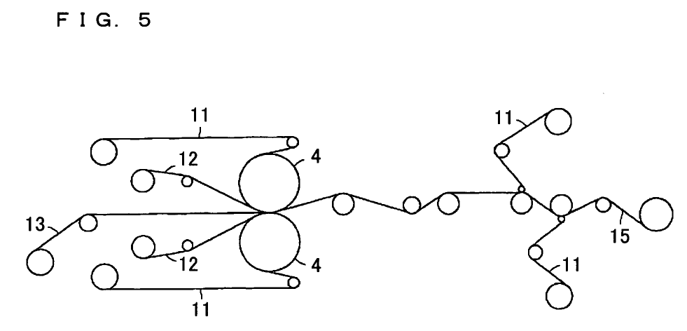

Referring to the schematic illustration in FIG. 5, the creases on the surface of the flexible laminate substrate 15 can be reduced by sandwiching a protective film (e.g. polyimide film) 11 between metal rolls 4 and a heat-resistant adhesive film 13 and between the metal rolls 4 and the metal foil 12 during thermally laminate. See, for example, Japanese Unexamined Patent Publication (Tokukai) 2001-129918. According to the method, the protective film 11 acts as such a buffer that the metal rolls 4 can apply uniform pressure during thermal lamination. In addition, the intervening protective film 11 provides protection to the surface of the metal rolls 4. The film 11 restricts quick thermal expansion of material and hence crease development because the laminate substrate is fixedly attached to the film 11.

The protective film 11 is thermally laminated together with the heat-resistant adhesive film 13 and the metal foil 12. After that, the film 11 is delaminated from the flexible laminate substrate 15 made of the heat-resistant adhesive film 13 and the metal foil 12.

The Tokukai 2001-129918 method prevents the flexible laminate substrate from creasing and curling, giving the substrate an excellent appearance. The protective film may not be smoothly delaminated or the appearance may not be proper yet, depending on how the protective film is delaminated. Accordingly, Japanese Unexamined Patent Publication (Tokukai) 2002-64259 discloses a method to reduce the curling of the flexible laminate substrate which may occur in the delaminating of the protective film. The reduction of the curling is achieved by delaminating a protective film, firmly attached to the top and bottom of the flexible laminate substrate, at symmetric angles. In addition, Japanese Unexamined Patent Publication (Tokukai) 2002-192615 discloses a method to reduce the creases of the flexible laminate substrate by delaminating a protective film firmly attached to the top and bottom of the flexible laminate substrate after cooling. Furthermore, Japanese Unexamined Patent Publication (Tokukai) 2002-370281 discloses a method to smoothly delaminate the protective film by specifying adhere strength between the protective film and the flexible laminate substrate in a range of 0.1 to 3 N/cm.

Neither Tokukai 2002-192615 nor Tokukai 2002-370281 however considers proper tension for a laminate in each step.

### BRIEF DESCRIPTION OF DRAWINGS

The present invention has an objective to provide a method of manufacturing a flexible laminate substrate involving thermal lamination with a pair of metal rolls. The method provides improved appearance and dimensional stability after the removal of metal foil.

The present invention is a method of manufacturing a flexible laminate substrate including a metal foil bonded onto at least one surface of a heat-resistant adhesive film. The method includes the steps of: thermally laminating the heat-resistant adhesive film and the metal foil between one or more pairs of metal rolls via a protective film to fabricate a laminate in which the heat-resistant adhesive film, the metal foil, and the protective film are bonded together; and delaminating the protective film. Greater tension is applied to the laminate during the delamination of the protective film than after the passage between the metal rolls.

In the method of manufacturing a flexible laminate substrate in accordance with the present invention, the tension on the laminate during the delamination of the protective film is preferably from 50 N/m to 500 N/m inclusive.

In the method of manufacturing a flexible laminate substrate in accordance with the present invention, the tension on the laminate after the passage between the metal rolls is preferably from 10 N/m to 200N/m inclusive.

In the method of manufacturing a flexible laminate substrate in accordance with the present invention, the tension after the passage between the metal rolls and before the delamination is preferably regulated using nip rolls.

In the method of manufacturing a flexible laminate substrate in accordance with the present invention, during the delamination of the protective film, the laminate preferably has a temperature less than or equal to a glass transition temperature of a heat-resistant adhesive film.

In the method of manufacturing a flexible laminate substrate in accordance with the present invention, the protective film is preferably non-thermoplastic.

### BRIEF DESCRIPTION OF DRAWINGS

FIG. 1 is a schematic illustrating a preferred example of a thermal laminator used in the present invention.

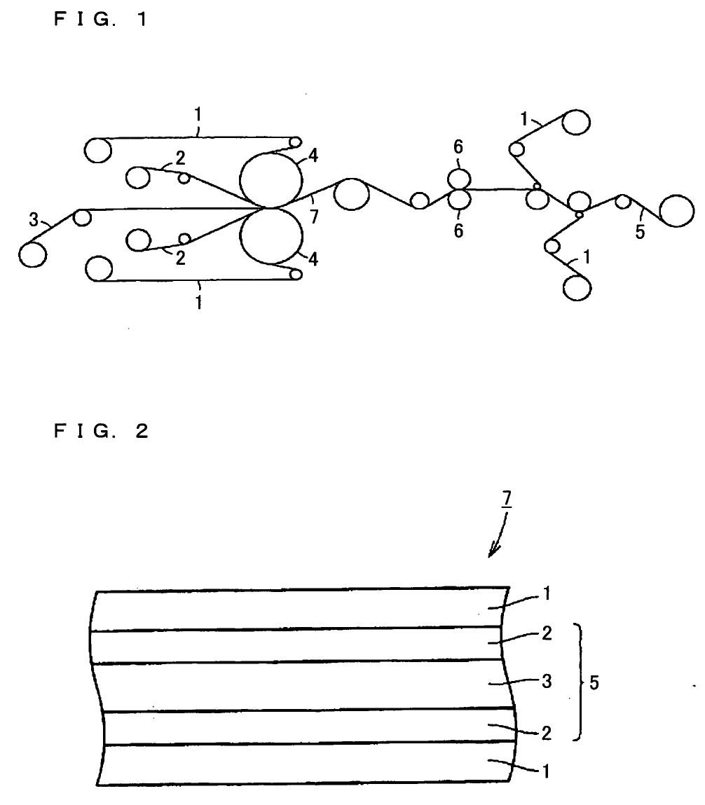

FIG. 2 is a schematic enlarged cross-sectional view of a laminate used in the present invention.

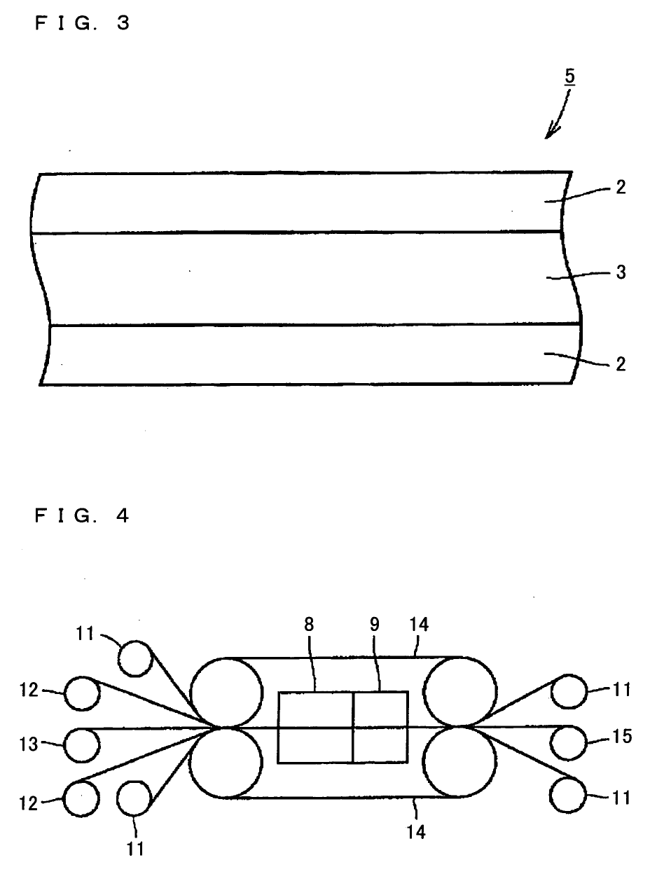

FIG. 3 is a schematic enlarged cross-sectional view of a flexible laminate substrate manufactured in the present invention.

FIG. 4 is a schematic illustrating an example of the conventional double-belt press machine.

FIG. 5 is a schematic illustrating an example of the conventional thermal laminator.

### REFERENCE NUMERALS

1, 11 Protective film
2, 12 Metal foil
3, 13 Heat-resistant adhesive film
4 Metal roll
5, 15 Flexible laminate substrate
6 Nip roll
7 Laminate
8 Heating section
9 Cooling section
14 Metal belt

### BEST MODE FOR CARRYING OUT INVENTION

The following will describe embodiments of the present invention. Throughout the figures of the present application, the same reference numerals refer to the same or equivalent parts.

FIG. 1 is a schematic illustrating a preferred example of a thermal laminator used in the present invention. The thermal laminator includes nip rolls 6 and a pair of metal rolls 4 for thermally laminating a metal foil 2 and a heat-resistant adhesive film 3 through a protective film 1.

In the thermal laminator, the pair of metal rolls 4 thermally laminates the protective film 1, the metal foil 2, and the heat-resistant adhesive film 3. After the thermal lamination, a laminate 7 is fabricated as shown in the schematic enlarged cross-sectional view in FIG. 2. The laminate 7 includes the protective film 1, metal foil 2, and heat-resistant adhesive film 3 being bonded together. The laminate 7 is gradually cooled while being transported by a plurality of rolls. After the laminate 7 has passed the nip rolls 6, the protective film 1 is being delaminated from the laminate 7. The delamination completes the manufacture of the flexible laminate substrate 5 shown in the schematic enlarged cross-sectional view in FIG. 3.

A feature of the present invention is that the laminate 7 comes under greater tension when the protective film 1 is being delaminated than after the laminate 7 has passed the metal rolls 4. This is achieved by, for example, the use of the nip rolls 6 or other tension varying means.

To delaminate the protective film 1 smoothly, the laminate needs to be under some tension. Under increased tension, the flexible laminate substrate experiences high tension also immediately after thermal lamination, which would result in improper appearance and dimensions of the flexible laminate substrate. Therefore, in the present invention, the tension on the flexible laminate 7 immediately after thermal lamination and the tension on the flexible laminate 7 when the protective film 1 is being delaminated are regulated to suitable levels. Hence, the laminate 7, hot after lamination, is gradually cooled down without being placed under high tension. The flexible laminate substrate 5 will less likely be distorted. Also, because of the reduced distortion of the flexible laminate substrate 5, the substrate 5 will less likely deform when it is freed from the distortion after the metal foil 2 is partly removed from the substrate 5. These factors improve the dimensional stability of the flexible laminate substrate 5. The protective film 1 is smoothly delaminated by specifying the tension on the laminate 7 when the protective film 1 is being delaminated to a higher level than before delamination. The flexible laminate substrate 5 will less likely develop creases and other defects in appearance. Thus, in the present invention, the flexible laminate substrate 5 can be manufactured with improved appearance and dimensional stability after the removal of the metal foil 2. Here, the nip rolls 6 is used as tension varying means; the means may be implemented in any other way.

The tension on the laminate 7 when the protective film 1 is being delaminated is preferably from 50 N/m to 500 N/m inclusive, more preferably from 200 N/m to 300 N/m inclusive. If the tension on the laminate 7 when the protective film 1 is being delaminated is less than 50 N/m, the tension on the laminate 7 is so low that the flexible laminate substrate 5 may be pulled out of place by the protective film 1 as the protective film 1 is delaminated. The protective film 1 is not smoothly delaminated, causing creases and other defects in the appearance of the flexible laminate substrate 5. Meanwhile, if the tension on the laminate 7 when the protective film 1 is being delaminated is greater than 500 N/m, the tension on the laminate 7 is so high that the flexible laminate substrate 5 may develop lines along its length or other defects in appearance or that the flexible laminate substrate 5 may be distorted and change greatly in dimension after the metal foil 2 is removed. Under right conditions, the protective film 1 will likely be smoothly delaminated, and the flexible laminate substrate 5 will less likely develop creases or other defects in appearance or change in dimension after the metal foil 2 is removed. This is especially true if the tension on the laminate 7 when the protective film 1 is being delaminated is from 200 N/m to 300 N/m inclusive.

The tension on the laminate 7 after having passed the metal rolls 4 is preferably from 10 N/m to 200 N/m inclusive. If the tension on the laminate 7 after having passed the metal rolls 4 is less than 10 N/m, the laminate 7 may slack during transportation, causing the protective film 1 to go off the laminate 7 while the laminate 7 is being transported. When there are provided more than one pair of metal rolls, the “tension on the laminate 7 after having passed the metal rolls 4” refers to the tension on the laminate after the laminate has passed the last pair. After passing metal rolls, the laminate is hot and may be difficult measure tension. One can transport the laminate under a certain tension until the laminate cools down, before making measurement.

If the protective film 1, to which the flexible laminate substrate 5 is fixedly attached, is delaminated before the flexible laminate substrate 5 is sufficiently cooled, the flexible laminate substrate 5 may quickly expand or shrink, developing appearance defects. If the laminate 7 slackens, the laminate 7 may sway during transportation. This may in turn lead to creases and other appearance defects when the flexible laminate substrate 5 is reeled. If the tension on the laminate 7 after having passed the metal rolls 4 is greater than 200 N/m, the laminate 7 is pulled with strong force before being sufficiently cooled (more accurately, when the interface between the metal foil 2 and the heat-resistant adhesive film 3 is still melting). The flexible laminate substrate 5 may be distorted and develop appearance defects and increased dimensional changes after the removal of the metal foil 2.

The ratio of the tension on the laminate 7 after having passed the metal rolls 4 to the tension on the laminate 7 when the protective film is being delaminated is preferably 1.2 to 10, more preferably 1.5 to 6, because with these values, one can obtain a flexible laminate substrate which has an excellent appearance and experiences reduced dimensional changes after the removal of the metal foil 2.

Throughout this specification, the tension on a laminate refers to the tension in the MD direction (the direction in which the laminate is transported. The tension on a laminate can be measured by placing a roll with a built-in sensor to a production line. The tension on a laminate before the delamination of the protective film can be obtained, throughout the specification, by measuring the tension on the laminate from immediately after thermal lamination, up to but not including nip rolls or other tension varying means. The tension on a laminate when the protective film is being delaminated can be obtained by measuring the tension on the laminate before and after the delamination of the protective film.

The temperature of the laminate 7 when the protective film 1 is being delaminated is preferably less than or equal to the glass transition temperature of the thermally fusing resin contained in the adhesive layer of the heat-resistant adhesive film 3, more preferably, lower than the temperature of that resin by 50° C. or more, even more preferably, by 100° C. or more, and still preferably, such a temperature that the protective film 1 is delaminated when the laminate 7 is cooled down to room temperature. If the adhesive layer contains thermosetting content, thermal lamination may be possible at lower temperatures than these temperatures, depending on thermal lamination rate.

If the protective film 1 is delaminated at higher temperature than the glass transition temperature of the heat-resistant adhesive film 3, the heat-resistant adhesive film 3 will likely deform, which in turn may cause creases and hence appearance defects on the flexible laminate substrate 5. When the heat-resistant adhesive film 3 includes a plurality of layers, hence a plurality of adhesive layers with different glass transition temperatures, the glass transition temperature under consideration is defined as the lowest of the glass transition temperatures of the thermally fusing resins contained in the adhesive layers.

The protective film 1 is preferably a film of non-thermoplastic resin. Non-thermoplastic resin in practice has no glass transition temperature. The resin hardly sticks to the metal rolls 4 in thermal lamination, likely facilitating the delamination of the protective film 1 off the laminate 7. The linear expansion coefficient of the protective film 1 is preferably 50 ppm/° C. or less, more preferably 35 ppm/° C. or less. If the linear expansion coefficient of the protective film 1 is more than 50 ppm/° C., the protective film 1 expands/shrinks greatly during heating for thermal lamination and cooling after the thermal lamination when compared to the flexible laminate substrate 5, which may cause the flexible laminate substrate 5 to crease. The thickness of the protective film 1 is preferably 75 μm or more, more preferably, 100 μm or more, and even more preferably 125 μm or more. If the thickness of the protective film 1 is less than 75 μm, the protective film 1 is too thin to resist the shrinking of the flexible laminate substrate 5 as they cool down, likely allowing the flexible laminate substrate 5 to crease. If the thickness of the protective film 1 increases up to 75 μm or more, or 125 μm or more, the protective film 1 is better able to resist the shrinking of the flexible laminate substrate 5 when they cool down, less likely allowing the flexible laminate substrate 5 to crease.

The metal foil 2 is, for example, a copper foil, a nickel foil, an aluminum foil, or a stainless steel foil. The metal foil 2 may be either a single layer or multiple layers including an antirust layer and/or a heat-resistant layer (formed by, for example, chromium, zinc, or nickel plating) on the surface. Among these examples, the metal foil 2 is preferably a copper foil in view of electrical conductance and cost. Copper foil may be of a rolling type or an electrolysis type, for example. Since the thinner the metal foil 2, the narrower the circuit pattern lines on the printed circuit board, the thickness of the metal foil 2 is preferably 35 μm or less, more preferably, 18 μm or less.

The heat-resistant adhesive film 3 may be, among other examples, either a single-layered film of a thermally fusing resin or a multilayered film containing non-thermally fusing core layer with an adhesive thermally-fusing-resin layer provided on each or both surfaces thereof. The thermally fusing resin is preferably a resin containing a thermoplastic polyimide component: for example, thermoplastic polyimide, thermoplastic polyamide imide, thermoplastic polyether imide, or thermoplastic polyester imide. Among these examples, thermoplastic polyimide and thermoplastic polyester imide are preferred to the others. The adhesive layer may contain, in addition to the thermally fusing resin, epoxy resin, acrylic resin, or other thermosetting resins for improved adhesion properties.

The non-thermally fusing core layer may be, for example, a non-thermoplastic polyimide film, an aramide film, a polyether ether ketone film, a polyether sulfonic film, a polyarylate film, or a polyethylene naphthalate film. Among these examples, non-thermoplastic polyimide film is preferred to the others in view of electrical properties (electrical insulation) and affinity with thermally fusing resins.

The temperature at which the metal rolls 4 carries out thermal lamination is preferably higher than the glass transition temperature of the thermally fusing resin contained in the adhesive layer of the heat-resistant adhesive film 3 by 50° C. or more, more preferably, higher than the glass transition temperature of the heat-resistant adhesive film 3 by 100° C. or more for improved thermal lamination rate. If the adhesive layer contains thermosetting content, thermal lamination may be possible at lower temperatures than these temperatures, depending on thermal lamination rate. The metal rolls 4 may be heated by a heat medium circulate scheme, a hot air scheme, or a dielectric heating scheme, for example. The present invention is achieves excellent effects when the thermal lamination temperature is 300° C. or more, preferably, 350° C. or more.

The pressure (linear pressure) applied by the metal rolls 4 in thermal lamination is preferably from 49 N/cm to 490 N/cm inclusive, more preferably, from 98 N/cm to 294 N/cm inclusive. If the linear pressure in thermal lamination is less than 49 N/cm, the linear pressure will likely be too low to ascribe proper adhesion properties between the metal foil 2 and the heat-resistant adhesive film 3. If the linear pressure is more than 490 N/cm, the linear pressure is so high that the flexible laminate substrate 5 may be distorted and the flexible laminate substrate 5 after the removal of the metal foil 2 may experience large dimensional changes. If the linear pressure in thermal lamination is from 98 N/cm to 294 N/cm inclusive, especially good adhesion properties develop between the metal foil 2 and the heat-resistant adhesive film 3, and the flexible laminate substrate 5 after the removal of the metal foil 2 experiences reduced dimensional changes. The metal rolls 4 may apply pressure by means of oil or air, or by an inter-gap pressure scheme, for example.

The thermal lamination rate is preferably 0.5 m/min or more and more preferably 1 m/min or more. If the thermal lamination rate is 0.5 m/min or more, especially if 1 m/min or more, productivity is greatly improved for the flexible laminate substrate 5 which has improved appearance and dimensional stability after the removal of the metal foil 2.

The protective film 1, metal foil 2, and heat-resistant adhesive film 3 are preferably preheated before thermal lamination to avoid rapid temperature rises. The protective film 1, metal foil 2, and heat-resistant adhesion film 3 are preheated through contact with a heater roll, for example.

It is preferable to provide a step to remove foreign objects from the protective film 1, metal foil 2, and heat-resistant adhesive film 3 before thermal lamination. The removal of foreign objects sticking to the protective film 1 is crucial, especially, to reuse the protective film 1 repeatedly. Foreign objects may be removed by washing in water or a solvent or using an adhesive rubber roll, for example. Among these choices, an adhesive rubber roll is more preferred because it is a simple tool

It is preferable to provide a step to remove static electricity from the protective film 1 and the heat-resistant adhesive film 3 before thermal lamination. The films 1, 3 may be discharged in discharging air, for example.

### EXAMPLES

### Example 1

A flexible laminate substrate was manufactured using the thermal laminator in FIG. 1. First, rolls were mounted to the thermal laminator. A non-thermoplastic polyimide film as the protective film 1 was wound around rolls. The film was 125-μm thick and had a linear expansion coefficient of 16 ppm/° C. at 200° C. to 300° C. A copper foil as the metal foil 2 was wound around other rolls. The foil was 18-μm thick. Around another roll was wound a three-layered adhesive film as the heat-resistant adhesive film 3. The film was made up of a core layer of a non-thermoplastic polyimide film and a thermoplastic polyimide resin component (glass transition temperature: 240° C.) on each surface thereof. The film was 25-μm thick.

Next, the roll were rotated, discharged, rid of foreign objects, and preheated. After that, the protective films, the copper foils, and the adhesive film were thermally laminated with the protective films 1 being wound half way around, and preheated by, the pair of metal rolls 4. The thermal lamination was carried out under the conditions listed in Table 1 (temperature: 360° C., linear pressure: 196 N/cm, thermal lamination rate: 1.5 m/min). The laminate 7, fabricated as above, had a five-layered structure in which a copper foil and a non-thermoplastic polyimide film were bonded in this order onto each surface of the adhesive film.

A plurality of rolls were used to transport the laminate 7 under 60 N/m tension while letting the laminate 7 naturally cool down. This tension was equal to the tension after passing the metal rolls. Thereafter, the laminate 7 was temporarily released from tension using the nip rolls 6, before the tension on the laminate 7 was raised to 250 N/m. The laminate 7 was then cooled down to room temperature (25° C.). The non-thermoplastic polyimide films were delaminated with the laminate 7 under 250 N/m tension, which concluded the manufacture of the flexible laminate substrate 5.

The appearance and dimensional stability (in MD and TD directions) of the flexible laminate substrate were evaluated as follows. Results are shown in Table 1.

i) Evaluation of Appearance

Creases on the flexible laminate substrate were counted. The values were converted into counts per square meters. The following A to E scale was used in the evaluation.

A: 0 creases.

B: 1 or fewer creases per square meters.

C: 2 to 3 creases per square meters.

D: 4 to fewer than 6 creases per square meters.

E: 6 or more creases per square meters.

ii) Evaluation of Dimensional Stability

Distances between four holes in the flexible laminate substrate were measured according to JIS C6481. Next, the copper foils were partly removed by etching, and the samples were left in a temperature-controlled room at 20° C. and 60% RH for 24 hours. The distances between the four holes were measured again as they were before etching. Rates of dimensional change were calculated using the equation below for evaluation. The smaller the absolute value of the rate, the better the dimensional stability.

$$Rate of Dimensional Change ( \% ) = \{ ( Distance after Removal - Distance before Removal ) / ( Distance before Removal ) \} \times 100$$

[Rate of Dimensional Change]

The rates of dimensional change before and after metal foil removal were calculated from measurements based on JIS C6481 as follows. A square sample was cut out of a 200 mm×200 mm flexible laminate substrate. On the sample, a hole with a 1-mm diameter was formed at the each corner of a 150 mm×150 mm square. Two sides of the 200 mm×200 mm square sample and the 150 mm×150 mm square were taken along the MD direction, and the other two sides were taken along the TD direction. The two squares were made to have a common center. The sample was left in a temperature/humidity-controlled room at 20° C. and 60% RH for 12 hours for humidity control. After that, the distances between the four holes were measured. Then, the metal foils were removed from the flexible laminate substrate by an etch process. The sample was left in a temperature-controlled room at 20° C. and 60% RH for 24 hours. The distances between the four holes were measured as they were before the etch process. The rates of dimensional change were calculated from equation (3) below. D1 is the measurement of a hole distance before the removal of the metal foils. D2 is the measurement of the hole distance after the removal of the metal foils. The smaller the absolute value of the rate, the better the dimensional stability.
Rate of Dimensional Change (%)={(D2−D1)/D1}×100 (3)

As shown in Table 1, no creases developed at all on the flexible laminate substrate of example 1. The dimensional stabilities in the MD direction and the TD direction (at right angles to the MD direction) were +0.03% and −0.02% respectively.

### Example 2

A flexible laminate substrate was manufactured similarly to example 1, except that the tension on the laminate when the non-thermoplastic polyimide films as protective films were delaminated was specified to 300 N/m. The appearance and dimensional stability of the flexible laminate substrate were evaluated similarly to example 1. Evaluation results are shown in Table 1.

As shown in Table 1, less than one crease developed per square meters of the flexible laminate substrate of example 2. The dimensional stabilities in the MD direction and the TD direction were +0.04% and −0.03% respectively.

### Example 3

A flexible laminate substrate was manufactured similarly to example 1, except that the tension on the laminate before the non-thermoplastic polyimide films as protective films were delaminated was specified to 50 N/m. The appearance and dimensional stability of the flexible laminate substrate were evaluated similarly to example 1. Evaluation results are shown in Table 1.

As shown in Table 1, no creases developed at all on the flexible laminate substrate of example 3. The dimensional stabilities in the MD direction and the TD direction are +0.03% and −0.02% respectively.

### Example 4

A flexible laminate substrate was manufactured similarly to example 1, except that the tension on the laminate before the non-thermoplastic polyimide films as protective films were delaminated was specified to 50 N/m, and the tension on the laminate 7 during delamination was specified to 300 N/m. The appearance and dimensional stability of the flexible laminate substrate were evaluated similarly to example 1. Evaluation results are shown in Table 1.

As shown in Table 1, less than one crease developed per square meters of the flexible laminate substrate of example 4. The dimensional stabilities in the MD direction and the TD direction were +0.04% and −0.03% respectively.

### Example 5

A flexible laminate substrate was manufactured similarly to example 1, except that the tension on the laminate before the non-thermoplastic polyimide films as protective films were delaminated was specified to 80 N/m, and the tension on the laminate during delamination was specified to 200 N/m. The appearance and dimensional stability of the flexible laminate substrate were evaluated similarly to example 1. Evaluation results are shown in Table 1.

As shown in Table 1, less than one crease developed per square meters of the flexible laminate substrate of example 5. The dimensional stabilities in the MD direction and the TD direction were +0.03% and −0.03% respectively.

### Example 6

A flexible laminate substrate was manufactured similarly to example 1, except that the tension on the laminate before the non-thermoplastic polyimide films as protective films were delaminated was specified to 80 N/m, and the tension on the laminate during delamination was specified to 150 N/m. The appearance and dimensional stability of the flexible laminate substrate were evaluated similarly to example 1. Evaluation results are shown in Table 1.

As shown in Table 1, one to fewer than 3 creases developed per square meters of the flexible laminate substrate of example 6. The dimensional stabilities in the MD direction and the TD direction were +0.05% and −0.04% respectively.

### Example 7

A flexible laminate substrate was manufactured similarly to example 1, except that the tension on the laminate before the non-thermoplastic polyimide films as protective films were delaminated was specified to 100 N/m, and the tension on the laminate during delamination was specified to 200 N/m. The appearance and dimensional stability of the flexible laminate substrate were evaluated similarly to example 1. Evaluation results are shown in Table 1.

As shown in Table 1, less than one crease developed per square meters of the flexible laminate substrate of example 7. The dimensional stabilities in the MD direction and the TD direction were +0.04% and −0.04% respectively.

### Example 8

A flexible laminate substrate was manufactured similarly to example 1, except that the tension on the laminate before the non-thermoplastic polyimide films as protective films were delaminated was specified to 100 N/m, and the tension on the laminate during delamination was specified to 150 N/m. The appearance and dimensional stability of the flexible laminate substrate were evaluated similarly to example 1. Evaluation results are shown in Table 1.

As shown in Table 1, one to fewer than 3 creases developed per square meters of the flexible laminate substrate of example 7. The dimensional stabilities in the MD direction and the TD direction were +0.05% and −0.04% respectively.

### Comparative Example 1

A flexible laminate substrate was manufactured similarly to example 1, except that no nip rolls were used, the tensions on the laminate before the non-thermoplastic polyimide films as protective films were delaminated and during delamination were both specified to 250 N/m. The appearance and dimensional stability of the flexible laminate substrate were evaluated similarly to example 1 Evaluation results are shown in Table 1.

As shown in Table 1, 5 or more creases developed per square meters of the flexible laminate substrate of comparative example 1. The dimensional stabilities in the MD direction and the TD direction were +0.12% and −0.08% respectively.

### Comparative Example 2

A flexible laminate substrate was manufactured similarly to example 1, except that the tension on the laminate before the non-thermoplastic polyimide films as protective films were delaminated was specified to 300 N/m, and the tension on the laminate during delamination was specified to 250 N/m. The appearance and dimensional stability of the flexible laminate substrate were evaluated similarly to example 1. Evaluation results are shown in Table 1.

As shown in Table 1, 5 or more creases developed per square meters of the flexible laminate substrate of comparative example 2. The dimensional stabilities in the MD direction and the TD direction were +0.15% and −0.09% respectively.

TABLE 1

| | Manufacturing conditions | | | | | | | |
|---|---|---|---|---|---|---|---|---|
| | Conditions | | | | | Evaluation | | |
| | for thermal lamination | | | Tension | | | Dimensional | |
| | | | Thermal | on laminate | | | stability | |
| | | Linear | lamination | Before | During | | MD | TD |
| | Temperature | pressure | rate | delamination | delamination | | direction | direction |
| | (° C.) | (N/cm) | (m/min) | (N/m) | (N/m) | Appearance | (%) | (%) |
| Example 1 | 360 | 196 | 1.5 | 60 | 250 | A | −0.03 | +0.02 |
| Example 2 | 360 | 196 | 1.5 | 60 | 300 | B | −0.04 | +0.03 |
| Example 3 | 360 | 196 | 1.5 | 50 | 250 | A | −0.03 | +0.02 |
| Example 4 | 360 | 196 | 1.5 | 50 | 300 | B | −0.04 | +0.03 |
| Example 5 | 360 | 196 | 1.5 | 80 | 200 | B | −0.03 | +0.03 |
| Example 6 | 360 | 196 | 1.5 | 80 | 150 | C | −0.05 | +0.04 |
| Example 7 | 360 | 196 | 1.5 | 100 | 200 | B | −0.04 | +0.04 |
| Example 8 | 360 | 196 | 1.5 | 100 | 150 | C | −0.05 | +0.04 |
| Comparative | 360 | 196 | 1.5 | 250 | 250 | E | −0.12 | +0.08 |
| Example 1 | | | | | | | | |
| Comparative | 360 | 196 | 1.5 | 300 | 250 | E | −0.15 | +0.09 |
| Example 2 | | | | | | | | |

As shown in Table 1, the flexible laminate substrates of examples 1 to 8 are superior both in appearance and dimensional stability to the flexible laminate substrates of comparative examples 1 and 2. The former were manufactured with the tension on the laminate being greater when the non-thermoplastic polyimide films as protective films are being delaminated than before the delamination. The flexible laminate substrate of comparative example 1 was manufactured with equal tensions during delamination and before delamination. The flexible laminate substrate of comparative example 2 was manufactured with the tension being greater before delamination than during delamination.

Still referring to Table 1, the flexible laminate substrates of examples 1 to 5 and 7 had better appearances with fewer creases and lower rates of dimensional change after the removal of the copper foils than the flexible laminate substrates of examples 6 and 8. For the former, the tension on the laminate when the non-thermoplastic polyimide films as protective films are being delaminated was from 200 N/m to 300 N/m inclusive. The tension on the laminate during the delamination was 150 N/m for the latter ones.

The embodiments and examples disclosed here are mere illustrative examples in every respect. They should not be interpreted as limiting the invention. The scope of the invention is defined in the claims, not the description above. Equivalent variations and those within the scope of the patent claims are all within the meets and bounds of the invention.

### INDUSTRIAL APPLICABILITY

The present invention provides a manufacturing method of a flexible laminate substrate with improved appearance and dimensional stability after the removal of metal foils.

The invention can manufacture a flexible laminate substrate with excellent appearance and dimensional stability after the removal of metal foils. The invention is favorably utilized in the manufacture of electrical appliances, especially, printed circuit boards for mobile phones.

1. A method of manufacturing a flexible laminate substrate including a metal foil bonded onto at least one surface of a heat-resistant adhesive film, the method comprising the steps of:
thermally laminating the heat-resistant adhesive film and the metal foil between one or more pairs of metal rolls via a protective film to fabricate a laminate in which the heat-resistant adhesive film, the metal foil, and the protective film are bonded together; and
delaminating the protective film,
greater tension being applied to the laminate during the delamination of the protective film than after the passage between the metal rolls.

2. The method of claim 1, wherein the tension on the laminate during the delamination of the protective film is from 50 N/m to 500 N/m inclusive.

3. The method of claim 1, wherein the tension on the laminate after the passage between the metal rolls is from 10 N/m to 200 N/m inclusive.

4. The method of claim 1, wherein the tension after the passage between the metal rolls and before delamination is regulated using nip rolls.

5. The method of claim 1, wherein during the delamination of the protective film, the laminate has a temperature less than or equal to a glass transition temperature of an adhesive layer in the heat-resistant adhesive film.

6. The method of claim 1, wherein the protective film is non-thermoplastic.
